(19) United States
(12) Patent Application Publication
(10) Pub. No.: US 2025/0326966 A1
(43) Pub. Date: Oct. 23, 2025

(54) ENHANCED OIL RECOVERY PROCESS WITH POLYMER FLOODING USING TREATED PRODUCED WATER

(71) Applicant: Saudi Arabian Oil Company, Dhahran (SA)

(72) Inventors: Subhash Ayirala, Dhahran (SA); Waleed Alhodythi, Dhahran (SA); Mustafa Satrawi, Anak (SA); Abdullah Boqmi, Dammam (SA); Salah Hamad Al-Saleh, Dhahran (SA); Ali Yousef, Dhahran (SA)

(21) Appl. No.: 18/642,279

(22) Filed: Apr. 22, 2024

(51) Int. Cl. C09K 8/588

(52) U.S. Cl. CPC C09K 8/588

(57) ABSTRACT

A method includes: removing at least some portions of salts, H₂S and oil from a produced water to provide a treated produced water; dissolving a polymer in the treated produced water at a polymer concentration from 100 parts per million (ppm) to 1000 ppm to provide a polymer solution having a viscosity from 5 cP (mPa·s) to 100 cP (mPa·s) at a temperature from 20° C. to 22° C.; and injecting the polymer solution into a subterranean formation through a wellbore to recover hydrocarbons trapped in the subterranean formation.

### TECHNICAL FIELD

This disclosure relates to methods of enhanced oil recovery (EOR) process with polymer flooding using treated produced water.

### BACKGROUND

Polymer flooding is one of the matured technologies for enhanced oil recovery (EOR) in both sandstone and carbonate reservoirs. The addition of polymer to the injection water increases the viscosity of water to lower the mobility and increase the sweep efficiency in porous media for EOR. However, a potential drawback of using polymers for EOR in carbonate reservoirs is that a relatively high polymer concentrations may be involved at harsh carbonate reservoir conditions involving high salinities and temperatures. Water chemistry of the aqueous phase used to achieve the desired viscosity with the polymer can impact the polymer concentration, and consequently the economics of polymer flooding projects.

### SUMMARY

This disclosure describes technologies relating to methods of EOR, more specifically to polymer flooding using treated produced water (TPW) to prepare a polymer solution, where the use of TPW can involve less polymer to achieve a target viscosity in comparison to seawater (SW). The methods of EOR herein can be applied in certain formations containing viscous crude oils such as carbonate reservoirs and sandstone reservoirs. The use of TPW to prepare the polymer solution for polymer flooding can recycle and reuse produced water generated in huge volumes during oil and gas production operations.

In some implementations, a method of EOR includes one or more pretreatment steps to remove the salts, hydrogen disulfide (H₂S), and oil from the produced water to provide the TPW. The polymer solution can be prepared from the TPW to have a viscosity between 5 cP (mPa·s) to 100 cP (mPa·s) at a temperature from 20° C. to 22° C. at a polymer concentration from 100 ppm to 1000 ppm. The prepared polymer solution can be injected into a subterranean formation, e.g., carbonate reservoirs, through a wellbore to recover hydrocarbons trapped in the subterranean formation.

In an implementation, a method includes: removing at least some portions of salts, H₂S and oil from a produced water to provide a treated produced water; dissolving a polymer in the treated produced water at a polymer concentration from 100 parts per million (ppm) to 1000 ppm to provide a polymer solution having a viscosity from 5 cP (mPa·s) to 100 cP (mPa·s) at a temperature from 20° C. to 22° C.; and injecting the polymer solution into a subterranean formation through a wellbore to recover hydrocarbons trapped in the subterranean formation.

In an aspect, combinable with any other aspect, a concentration of the salts in the produced water is from 50,000 ppm to 250,000 ppm, and a concentration of the salts in the treated produced water is less than 500 ppm.

In an aspect, combinable with any other aspect, a concentration of the salts in the produced water is from 20,000 ppm to 100,000 ppm, and a concentration of the salts in the treated produced water is less than 100 ppm.

In an aspect, combinable with any other aspect, removing of at least a portion of the salts from the produced water includes: heating the produced water to generate steam; and condensing the steam into a liquid.

In an aspect, combinable with any other aspect, a concentration of the H₂S in the produced water is from 100 ppm to 500 ppm, and a concentration of the H₂S in the treated produced water is less than 1 ppm.

In an aspect, combinable with any other aspect, a concentration of the H₂S in the produced water is from 50 ppm to 200 ppm, and a concentration of the H₂S in the treated produced water is less than 0.5 ppm.

In an aspect, combinable with any other aspect, removing of a portion of the H₂S from the produced water includes: flashing the produced water to form a gas including the H₂S; and capturing the H₂S in the gas using a gas scrubber.

In an aspect, combinable with any other aspect, a concentration of the oil in the produced water is from 50 ppm to 200 ppm, and a concentration of the oil in the treated produced water is less than 10 ppm.

In an aspect, combinable with any other aspect, a concentration of the oil in the produced water is from 20 ppm to 100 ppm, and a concentration of the oil in the treated produced water is less than 1 ppm.

In an aspect, combinable with any other aspect, the polymer includes a hydrolyzed polyacrylamide, a copolymer of acrylamide and acrylamide tertiary butyl sulfonate (ATBS), or a copolymer of acrylamide and acrylate.

In an aspect, combinable with any other aspect, the polymer solution has a viscosity from 5 cP (mPa·s) to 100 cP (mPa·s) at a temperature from 50° C. to 100° C.

In an aspect, combinable with any other aspect, the subterranean formation includes a carbonate reservoir or a sandstone reservoir.

In an implementation, a method includes: removing at least some portions of salts, H₂S and oil from a produced water to provide a treated produced water, the produced water including 50,000-250,000 parts per million (ppm) salts, 100-500 ppm hydrogen disulfide (H₂S), and 50-200 ppm oil to provide a treated produced water having a total salt content of less than 500 ppm, an H₂S content of less than 1 ppm, and an oil content of less than 10 ppm; dissolving a polymer in the treated produced water to form a polymer solution having a polymer concentration between 100 ppm and 1000 ppm, the polymer including a sulfonated polyacrylamide; and injecting the polymer solution into a subterranean carbonate formation through a wellbore to recover hydrocarbons trapped in the subterranean carbonate formation.

In an aspect, combinable with any other aspect, the polymer solution has a viscosity between 5 cP (mPa·s) to 100 cP (mPa·s) at a temperature from 20° C. to 22° C.

In an aspect, combinable with any other aspect the treated produced water has a total concentration of divalent cations of less than 2 ppm.

In an aspect, combinable with any other aspect, the produced water includes sulfates, chlorides, bicarbonates, sodium, potassium, calcium, and magnesium.

In an aspect, the treated produced water has a concentration for each of the sulfates, the potassium, the calcium, and the magnesium, of less than 2 ppm, and a concentration for each of the chlorides, the bicarbonates, the sodium of less than 50 ppm.

In an implementation, a method of oil production includes: drilling a wellbore into a subterranean carbonate formation including hydrocarbon; performing a primary production to recover the hydrocarbon through the wellbore from the subterranean carbonate formation; performing a secondary production to further recovering the hydrocarbon through the wellbore from the subterranean carbonate formation, the secondary production including injecting a fresh water into the subterranean carbonate formation through the wellbore, generating a produced water including salts, hydrogen disulfide (H₂S), and oil; pretreating the produced water to reduce an H₂S content, an oil content, and a total salt content in the produced water, thereby providing a treated produced water; preparing a polymer solution using the treated produced water, the polymer solution having a polymer concentration between 100 ppm and 1000 ppm; and performing an EOR, the EOR including injecting the polymer solution into the subterranean carbonate formation through the wellbore.

In an aspect, combinable with any other aspect the treated produced water has an H₂S content of less than 1 ppm, an oil content of less than 10 ppm, and a total salt content of less than 500 ppm.

In an aspect, combinable with any other aspect, the EOR further includes, after injecting the polymer solution into the wellbore, injecting a fluid to flush the injected polymer solution and the hydrocarbon out of the subterranean carbonate formation to a ground surface.

### BRIEF DESCRIPTION OF DRAWINGS

FIG. 1 is a schematic diagram of an EOR process in a well having a wellbore formed through the Earth surface into a subterranean formation.

FIGS. 2-4 are process flow diagrams of an EOR process with polymer flooding using produced water.

FIG. 5 is a graph showing the solution viscosity of polymer solutions as a function of the polymer concentration at 25° C.

FIG. 6 is a graph showing the solution viscosity of polymer solutions as a function of the polymer concentration at 75° C.

### DETAILED DESCRIPTION

Implementations described herein provide the methods of EOR from a wellbore in a subterranean formation using a polymer solution derived from produced water. In some implementations, the polymer flooding of this disclosure is particularly useful as a EOR process for carbonate formations. Generally, certain EOR processes that employ high salinity water/seawater typically use high dosages of polymer, e.g., 1000 ppm or greater, as compared to low salinity water to achieve decent viscosities required for proper mobility control in viscous oil recovery processes. Therefore, the use of high salinity water is typically limited to situations in which the availability of high salinity water, such as seawater, is readily available. Such high polymer dosage may become cost prohibitive to apply polymer flooding technology in certain formations containing viscous crude oils such as carbonate reservoirs and sandstone reservoirs. It is thus desired to develop a new effective method of polymer flooding for such reservoir formations. In various implementations, the method of polymer flooding for EOR using produced water can decrease the chemical consumption for the polymer solution. The produced water can be pretreated for removing various species such as sulfur, dispersed oil or hydrocarbons, and dissolved solids, e.g., inorganic salts.

Produced water is the water generated during oil and gas production operations and generally contains a relatively high concentration of salts, e.g., 50,000 ppm or greater. Huge volumes of hypersaline produced water are generated at oil and gas production sites daily, e.g., approximately 220 million barrels per day. The management, handling, and disposal of such vast quantities of produced water can pose a serious challenge to the environment. In certain implementations, an EOR process described in this disclosure can allow for recycling and reusing some fractions of the produced water and reduce the environmental footprint of the overall oil production operations.

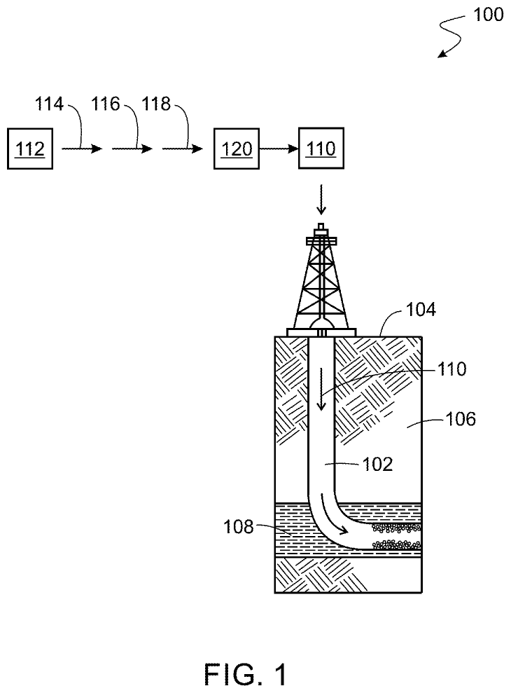

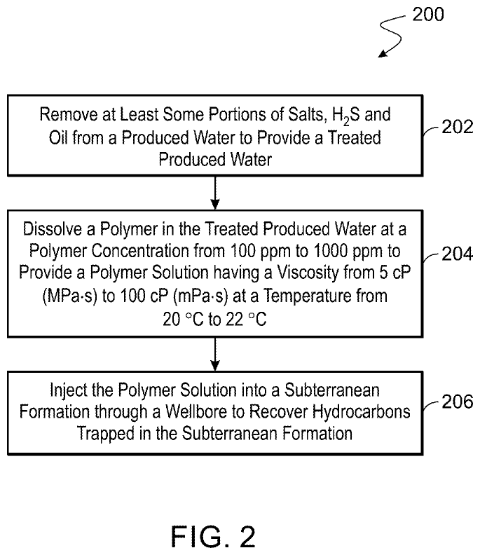

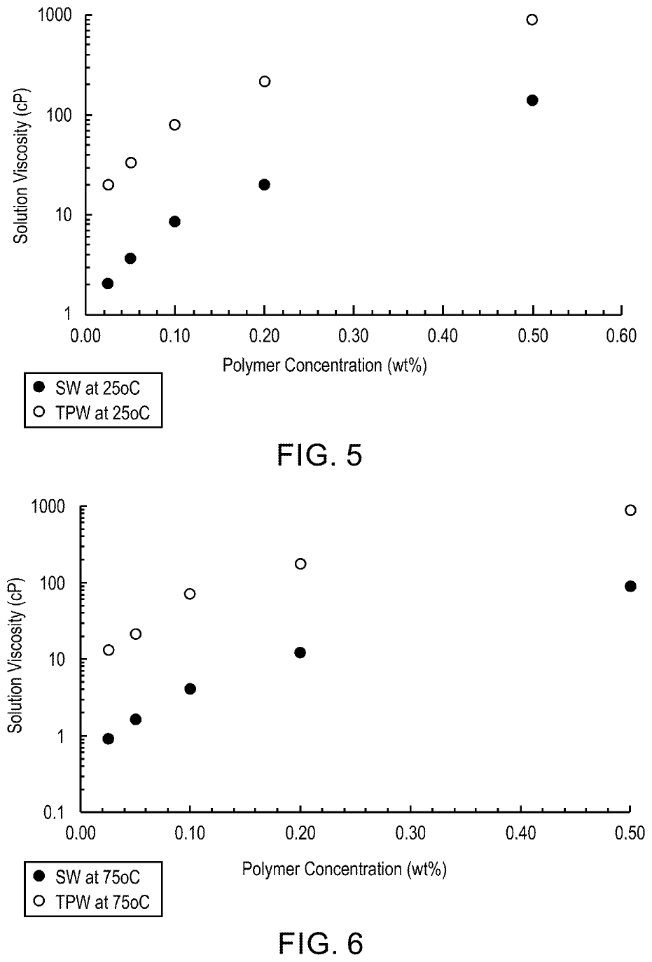

In the following, an overview of the produced water pretreatment and polymer flooding as EOR process at a well is described referring to FIG. 1. FIGS. 2-4 are example process flow diagrams for the polymer flooding in accordance with various implementations. Experimental results of viscosity study for a produced water-derived polymer solution are described referring to FIGS. 5 and 6.

As used herein, “total dissolved solids” or “TDS” refers to the sum of the combined amount of all inorganic salts contained in the injection water in the form of charged ions, such as monovalent ions and divalent ions. TDS can also be considered a measure of the salinity of a solution of interest.

FIG. 1 is a schematic diagram of an EOR process to recover hydrocarbon from a well 100. In FIG. 1, the well 100 has a wellbore 102 formed through the Earth surface 104 into a subterranean formation 106. The EOR process can be applied to the well 100 to recover hydrocarbons from the subterranean formation 106. In FIG. 1, the wellbore 102 has a horizontal portion in a hydrocarbon reservoir section 108 of the subterranean formation 106. The disclosure is not limited to such a configuration. In general, the wellbore 102 can include one or more sections that are vertical, horizontal, and/or deviated. The wellbore 102 can be an openhole but is generally a cased wellbore. The annulus between the casing and the subterranean formation 106 can be cemented. Perforations can be formed through the casing and cement into the subterranean formation 106. The perforations may allow both for flow of fracturing fluid into the subterranean formation 106 and for flow of produced hydrocarbon from the subterranean formation 106 into the wellbore 102. The subterranean formation 106 can include carbonate reservoirs or sandstone reservoirs.

In various implementations, the EOR process includes polymer flooding that injects a polymer solution 110 through the wellbore 102 into the subterranean formation 106 for oil recovery. The polymer solution 110 can be prepared from a produced water 112 as a base fluid after treating the produced water 112 (see discussion below) to remove various impurities such as sulfur, dispersed oil, and salts.

### Produced Water Composition

The produced water 112 is a water generated from one or more oil and gas production operation processes, e.g., from a gas-oil-separation plant (GOSP). In some implementations, the produced water 112 is obtained from waterflooding operations that injects a fresh water into the subterranean formation 106 through the wellbore 102. The injected fresh water during the waterflooding can be recovered at the Earth surface 104 as the produced water 112 along with the produced hydrocarbons.

Generally, the EOR process is applied as an oil recovery method after preceding oil and gas production operations are completed. For example, once a new well is constructed, a primary production is performed as an initial phase of hydrocarbon extraction using the natural flow or inherent reservoir pressure. After the primary production, a secondary production can be performed, for example, by waterflooding. After the secondary production, an EOR process can be applied. Accordingly, in some implementations, the method of polymer flooding can be applied after the first and second production stages. Further, the produced water 112 can be obtained from the secondary production.

In various implementations, the produced water 112 contains various components such as inorganic salts, sulfur species such as hydrogen sulfide (H₂S), dispersed oil, heavy metals, and emulsified and non-soluble organics. The total content of the dissolved inorganic salts can be represented as total dissolved solids (TDS). In some implementations, the TDS of the produced water 112 is at least 50,000 parts per million (ppm), e.g., at least 75,000 ppm, at least 10,000 ppm, or at least 125,000 ppm, and/or at most 250,000 ppm, e.g., at most 225,000 ppm, at most 200,000 ppm, or at most 175,000 ppm. In some implementations, the TDS is from 50,000 ppm to 250,000 ppm, e.g., from 100,000 ppm to 250,000 ppm, from 150,000 ppm to 250,000 ppm, from 200,000 ppm to 250,000 ppm, from 50,000 ppm to 200,000 ppm, from 50,000 ppm to 150,000 ppm, or from 50,000 ppm to 100,000 ppm. In some implementations, the TDS is from 20,000 ppm to 100,000 ppm.

Examples of the inorganic salts present in the produced water 112 include but are not limited to sulfates, chlorides, bicarbonates, and combinations thereof. The salts can be, for example, those of sodium, potassium, calcium, magnesium, and combinations thereof.

In various implementations, the H₂S content of the produced water 112 is at least 100 ppm, e.g., at least 200 ppm, or at least 400 ppm, and/or at most 500 ppm, e.g., at most 400 ppm, or at most 300 ppm. In some implementations, the H₂S content is from 100 ppm to 500 ppm, e.g., from 200 ppm to 500 ppm, from 300 ppm to 500 ppm, from 400 ppm to 500 ppm, from 100 ppm to 400 ppm, from 100 ppm to 300 ppm, or from 100 ppm to 200 ppm. In some implementations, the H₂S content is from 50 ppm to 200 ppm.

In various implementations, the dispersed oil content in the produced water 112 is at least 50 ppm, e.g., at least 75 ppm or at least 100 ppm, and/or at most 200 ppm, e.g., at most 175 ppm or at most 150 ppm. In some implementations, the dispersed oil content is from 50 ppm to 200 ppm, e.g., from 75 ppm to 200 ppm, from 100 ppm to 200 ppm, from 125 ppm to 200 ppm, from 150 ppm to 200 ppm, from 175 ppm to 200 ppm, from 50 ppm to 175 ppm, from 50 ppm to 150 ppm, from 50 ppm to 125 ppm, from 50 ppm to 100 ppm, or from 50 ppm to 75 ppm. In some implementations, the dispersed oil content is from 20 ppm to 100 ppm.

### Produced Water Pretreatment

In various implementations, the produced water 112 is processed for removing various species prior to preparing the polymer solution 110. The pretreatment stage can include steps such as desulfurization 114, de-oiling 116, and desalination 118 as illustrated in FIG. 1.

In some implementations, the desulfurization 114 of the produced water 112 reduces the H₂S content to less than 1 ppm, e.g., from 0.01 ppm to 1 ppm, from 0.05 ppm to 1 ppm, from 0.1 ppm to 1 ppm, from 0.3 ppm to 1 ppm, or from 0.7 ppm to 1 ppm. In some implementations, the H₂S content after the desulfurization 114 is less than 0.5 ppm.

In general, the technique for the desulfurization 114 can be selected depending on the initial H₂S content of the produced water 112. For example, a flashing technique can be used first to treat the produced water containing more than 100 ppm H₂S, and a post-flashing liquid stream can be further treated with H₂S scavenger chemicals, e.g., amines, and iron, zinc, or copper compounds to reduce the H₂S content to below 1 ppm. Examples of the H₂S scavenger chemicals include triethanolamine (TEA), diethanolamine (DEA), methyldiethanolamine (MDEA), monoethanolamine (MEA), diethanolamine (DEA), methyl diethanolamine (MDEA), iron oxide (FeO), iron chloride (FeCl₂), zinc oxide (ZnO), zinc chloride (ZnCl₂) copper oxide (CuO), and copper sulfate (CuSO₄).

In some implementations, the de-oiling 116 of the produced water 112 reduces the oil content to less than 10 ppm, e.g., from 0.1 ppm to 10 ppm, from 0.5 ppm to 10 ppm, from 1 ppm to 10 ppm, from 5 ppm to 10 ppm, from 1 ppm to 7 ppm, from 1 ppm to 5 ppm or from 1 ppm to 3 ppm. In some implementations, the oil content can be reduced to less than 1 ppm.

The technique for the de-oiling 116 can include filtration with ceramic ultrafiltration membranes, dissolved/induced gas floatation using air or nitrogen (N₂) gas, centrifuge, or deoiler hydrocyclones. In some implementations, induced N₂ gas floatation is used for the de-oiling 116 due to its flexibility in integration with a flashing process tank used in the desulfurization 114. Using this technique, in at least one implementation, the oil content of the produced water 112 can be reduced to less than 10 ppm with lower cost and footprint compared to some of the other techniques.

In some implementations, the desalination 118 of the produced water 112 reduces the total dissolved solids (TDS) to less than 500 ppm. For example, the TDS after the desalination 118 can be from 50 ppm to 500 ppm, from 50 ppm to 400 ppm, from 50 ppm to 300 ppm, from 50 ppm to 200 ppm, from 50 ppm to 100 ppm, from 10 ppm to 100 ppm, from 30 ppm to 100 ppm, from 50 ppm to 100 ppm, or from 70 ppm to 100 ppm. In one or more implementations, the concentration of a divalent cation, e.g., calcium and magnesium, after the desalination 118 is less than 2 ppm, e.g., from 0.5 ppm to 2 ppm, or from 0.5 ppm to 1 ppm.

The technique for the desalination 118 can include dynamic vapor compression (DyVaR), carrier gas extraction (CGE), or high-pressure reverse osmosis (HPRO). In DyVaR, the produced water 112 is heated to generate a steam, then passed through a compressor. The generated high-pressure steam is condensed back into liquid water with reduced salinity. The released heat during the compressor can be used to heat the incoming fluid for treatment. In some implementations, DyVaR is used for its relatively lower energy consumption when compared to other thermal based desalination techniques to obtain a treated fluid having a low-salinity, e.g., less than 500 ppm TDS. In CGE, the produced water 112 is passed through a bed of solid adsorbent material such as activated carbon or zeolite to capture the impurities. In HPRO, the produced water 112 is pressurized, ranging from about 70 to about 120 bar, and the compressed fluid is passed through a semi-permeable membrane to generate a cleaned water stream as permeate.

The series of pretreatments as described above generate a TPW 120 with relatively low salinity and reduced impurities of H₂S and oil. The order of pretreatments, e.g., the desulfurization 114, the de-oiling 116, and the desalination 118, illustrated in FIG. 1 is for example only, and other sequences can also be possible.

In some implementations, one or more of the pretreatments can be combined into one process to remove more than one type of components from the produced water 112 simultaneously, e.g., membrane filtration to remove some oil as well as salts. Further, although not specifically illustrated in FIG. 1, the pretreatment stage can include one or more steps to treat the produced water 112, e.g., filtration to remove suspended solids in the produced water 112.

Polymer Solution from Treated Produced Water (TPW)

After completing the pretreatment, the TPW 120 can be used as a base fluid to prepare the polymer solution 110. For the polymer solution 110, a polymer capable of increasing the viscosity of the TPW 120 can be used. Examples of such polymers include a hydrolyzed polyacrylamide, a copolymer of acrylamide and acrylamide tertiary butyl sulfonate (ATBS), or a copolymer of acrylamide and acrylate. In some implementations, copolymers of acrylamide and ATBS can tolerate reservoir temperatures up to 95° C., as in the prevailing carbonate reservoirs. In at least certain embodiments, the copolymer of acrylamide and acrylate can be from the standard Flopaam™ series polymers from SNF Floerger, France. In at least some embodiments, the copolymer of acrylamide and ATBS can be from the Flopaam™ AN series of polymers from SNF Floerger, France.

In general, the polymer solution 110 can be prepared in various ways. Typically, the process involves combining the polymer solution with the TPW 120, often while stirring the combination for a period of time. In some implementations, the preparation of the polymer solution 110 includes dissolving the polymer in the TPW 120, e.g., by the following steps: (1) stirring the TPW 120 with a magnetic stirrer in a beaker; (2) pouring the polymer slowly at the inner shoulder of vortex into the TPW 120; and (3) covering the beaker and leave the solution mixing overnight to obtain homogeneous polymer solution.

In various implementations, the polymer is added to the TPW 120 to provide a polymer concentration in the polymer solution 110 from 0.01 to 0.1 weight percent (wt. %) (100 ppm to 1000 ppm), alternately in the range from 0.03 wt. % (300 ppm) to 0.1 wt. % (1000 ppm), alternately in the range from 0.05 wt. % to 0.1 wt. %, alternately in the range from 0.07 wt. % to 0.1 wt. %, and alternately in the range from 0.09 wt. % to 0.1 wt. % to produce the polymer solution 110. In at least one embodiment, the polymer concentration in the polymer solution 110 is in the range from about 100 ppm to 1000 ppm. In at least one embodiment, the polymer concentration in the polymer solution is in the range from about 100 ppm to 500 ppm.

In conventional polymer flooding operations, the polymer concentration is typically 1000 ppm or greater in the injection fluid. In various implementations, the polymer solution 110 can exhibit a fluid property, e.g., viscosity, that is desirable for the process at a lower polymer concentration, less than 1000 ppm. Compared to a polymer-free fluid, the polymer present in the polymer solution 110 results in the polymer solution 110 having an enhanced macroscopic sweep efficiency. This can result in a relatively high incremental oil recovery.

In various implementations, the polymer solution 110 has a viscosity suitable for polymer flooding applications. For example, at a temperature from 20° C. to 22° C., the viscosity of the polymer solution 110 can be at least 5 cP (mPa·s), e.g., at least 10 cP (mPa·s), at least 20 cP (mPa·s), or 30 cP (mPa·s), and/or at most 100 cP (mPa·s), e.g., at most 90 cP (mPa·s), at most 80 cP (mPa·s), or at most 70 cP (mPa·s). In some implementations, at this temperature, the viscosity of the polymer solution 110 is from 5 cP (mPa·s) to 100 cP (mPa·s) at a temperature from 20° C. to 22° C., e.g., from 5 cP (mPa·s) to 50 cP (mPa·s), from 5 cP (mPa·s) to 20 cP (mPa·s), from 5 cP (mPa·s) to 10 cP (mPa·s), from 10 cP (mPa·s) to 100 cP (mPa·s), from 10 cP (mPa·s) to 75 cP (mPa·s), from 10 cP (mPa·s) to 50 cP (mPa·s), from 20 cP (mPa·s) to 100 cP (mPa·s), from 40 cP (mPa·s) to 100 cP (mPa·s), from 60 cP (mPa·s) to 100 cP (mPa·s), or from 80 cP (mPa·s) to 100 cP (mPa·s).

In various implementations, in the subterranean formation with an elevated temperature and pressure, the polymer solution 110 exhibits a fluid property suitable for mobilizing the trapped hydrocarbon. In some implementations, the viscosity of polymer solution 110 at a temperature from 50° C. to 100° C. under a pressure from 1000 psi (6.9 MPa) to 5000 psi (34.5 MPa) is at least 5 cP (mPa·s), e.g., at least 10 cP (mPa·s), at least 20 cP (mPa·s), or 30 cP (mPa·s), and/or at most 100 cP (mPa·s), e.g., at most 90 cP (mPa·s), at most 80 cP (mPa·s), or at most 70 cP (mPa·s). In some implementations, at this temperature, the viscosity of the polymer solution 110 is from 5 cP (mPa·s) to 100 cP (mPa·s) at a temperature from 50° C. to 100° C.

In some implementations, reducing the salinity of the produced water 112 before preparing the polymer solution 110 reduces the amount of polymer used to prepare the solution because the presence of salts in the solution can adversely impact the fluid property by lowing the viscosity with the polymer molecules becoming coiled with species such as divalent cations. On the hand, polymer molecules can swell and become elongated to increase viscosity in a low salinity solution such as the TPW 120.

In some implementations, the polymer solution 110 is in the absence of additives. Additives can include, but are not limited to, viscosifiers, surfactants, stabilizers, pH control agents, scale inhibitors.

### Polymer Flooding

In various implementations, an initial slug of the polymer solution 110 can be injected into the subterranean formation 106. The injected polymer solution provides better mobility control due to lowering of the viscosity contrast between polymer solution and the reservoir crude oil. As a result, the remaining oil will be mobilized and swept more efficiently.

In some implementations, the volume of the initial slug of the polymer solution 110 is about 0.3 pore volumes (PV), for example, from 0.3 PV to 0.5 PV. As used herein, “pore volume” refers to a unit of measure for void space available in the reservoir rock material. The injection of the polymer solution 110 can be performed as a repeated process of injections. After completing the polymer solution injection, another fluid, e.g., seawater or fresh water, can be injected to push the injected polymer solution and mobilized crude oil towards producing wells to the ground surface.

The use of the TPW 120 to prepare the polymer solution 110 can result in one or more improvements relative to certain conventional methods. For example, the lower polymer concentrations can lower the polymer storage volumes at the field site. Further, the polymer solution 110 can also ease post-polymer flooding operations at produced water handling facilities such as oil-water separation and chemical cleanup, because of the lower polymer concentrations in the produced fluids.

FIGS. 2-4 are example process flow diagrams of EOR processes in accordance with various implementations. In FIG. 2, in accordance with an implementation, a process 200 starts with a step 302 of removing at least some portions of salts, H₂S, and oil from a produced water. In some implementations, step 302 includes a series of separate treatments that individually remove the H₂S, the oil, and the salts. Subsequently, in a step 204, a polymer solution is prepared by dissolving a polymer in the treated produced water at a polymer concentration from 100 ppm to 1000 ppm, where the polymer solution has a viscosity between 5 cP (mPa·s) to 100 cP (mPa·s) at a temperature from 20° C. to 22° C. After step 204, a step 206 is performed in which the polymer solution is injected into a subterranean formation through a wellbore to recover hydrocarbons trapped in the subterranean formation.

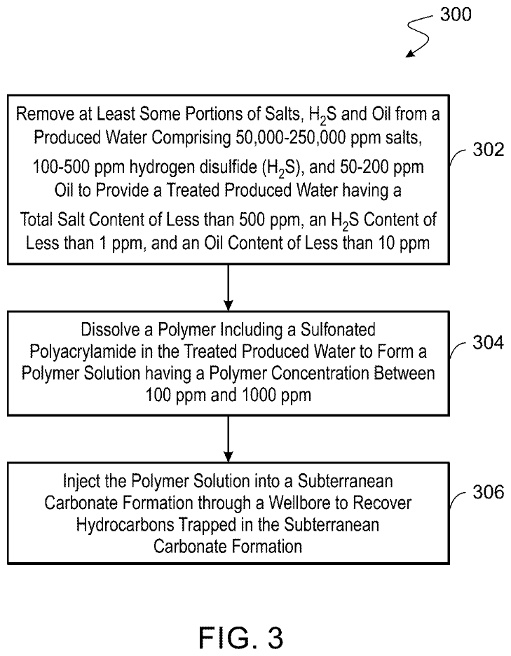

FIG. 3 shows another example process flow diagram of an EOR process for a carbonate formation using a specific type of polymer for a produced water having specific ranges of impurities. In FIG. 3, process 300 starts with a step 302 of removing at least some portions of salts, H₂S, and oil from a produced water containing 50,000-250,000 ppm salts, 100-500 ppm hydrogen disulfide (H₂S), and 50-200 ppm oil to provide a treated produced water. After step 302, the treated produced water has an H₂S content of less than 1 ppm, an oil content of less than 10 ppm, and a total salt content of less than 500 ppm. Subsequently, in a step 304, a polymer including a sulfonated polyacrylamide is dissolved in the treated produced water to form a polymer solution. The resulting polymer solution has a polymer concentration between 100 ppm and 1000 ppm. Subsequently, in a step 306, the polymer solution is injected into a subterranean carbonate formation through a wellbore to recover hydrocarbons trapped in the subterranean carbonate formation.

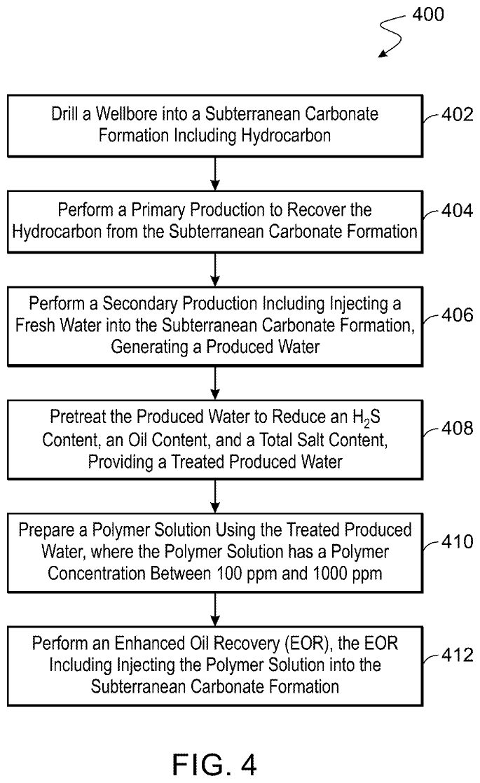

FIG. 4 shows another example process flow diagram of an EOR process for a carbonate formation, where a produced water obtained from a secondary production is used to prepare a polymer solution for the subsequent EOR process. In FIG. 4, a process 400 starts with a step 402 of drilling a wellbore into a subterranean carbonate formation including hydrocarbon. The process 500 then proceeds to a primary production 404 to recover the hydrocarbon through the wellbore from the subterranean carbonate formation, followed by a secondary production 406 to further recovering the hydrocarbon through the wellbore from the subterranean carbonate formation. The secondary production 406 can include injecting a fresh water into the subterranean carbonate formation through the wellbore, generating a produced water including salts, hydrogen disulfide (H₂S), and oil. After the secondary production 406, in a step 408, the produced water is pretreated to reduce an H₂S content, an oil content, and a total salt content in the produced water, providing a treated produced water. Subsequently, in a step 410, a polymer solution is prepared using the treated produced water, where the polymer solution has a polymer concentration between 100 ppm and 1000 ppm. An EOR process 412 is then performed, where the EOR process 412 includes injecting the polymer solution into the subterranean carbonate formation through the wellbore.

### EXAMPLES

The pretreatment and desalination of produced water was successfully demonstrated. A small stream sample of produced water with high salinity was collected from an oil-water separation plant. The sample was expected to contain about 80,000 ppm TDS, up to 500 ppm H₂S, and up to 200 ppm dispersed residual hydrocarbons. The sample was pretreated for removing H₂S and residual hydrocarbon contaminants by a series of processes as follows: N₂ induced gas floatation, vent gas scrubbing, and treatment with H₂S scavengers. This series of processes of pretreatment reduced the H₂S and dispersed oil content to less than 1 ppm and 10 ppm, respectively. This sample was then further processed by dynamic vapor compression (DyVaR) desalination to reduce the TDS to less than 200 ppm.

Table 1 summarizes the TDS of the produced water sample before and after the pretreatment. The identified species are sulfates, chlorides, bicarbonates, sodium, potassium, calcium, and magnesium. Sodium chloride was the dominant species in the produced water, followed by calcium species. The pretreatment reduced the TDS from over 80,000 ppm to less than 100 ppm. Each of the identified species was less than 50 ppm after the pretreatment. Specifically, sodium, chloride, and bicarbonate species were between 10 ppm and 50 ppm, while all the other species were less than 2 ppm. This demonstrates the effective removal of most salts form the produced water by the pretreatment including DyVaR.

TABLE 1
Produced water composition before and after desalination

| | Produced water | Produced water |
|---|---|---|
| | before treatment | after treatment |
| Species | Concentration (ppm) | Concentration (ppm) |
| Sulfate | 858 | 1 |
| Chloride | 47690 | 44 |
| Bicarbonate | 533 | 36 |
| Sodium | 21000 | 10 |
| Potassium | 706 | 0.3 |
| Calcium | 5290 | 1.5 |
| Magnesium | 991 | 0.3 |
| Total dissolved solids | 82079 | 99 |

The treated produced water (TPW) obtained from the experiment was further studied for the preparation of a polymer solution. The polymer solution was prepared form the TPW by dissolving a sulfonated polyacrylamide polymer having a sulfonation degree of 25 mol % and a molecular weight of 12 million Dalton (Da) (12×10⁶ g/mol). A reference polymer solution was also prepared from seawater (SW) and compared with the polymer solution from the TPW. The effect of the polymer on the viscosity in the two water chemistries at different concentrations (0.025 wt. % to 0.5 wt. %) were investigated using a Brookfield Viscometer at 6.8 sec⁻¹ shear rate. The measurements were conducted at 25° C. and 75° C. The prepared solution was placed in the viscometer and the spindle was selected based on the expected solution viscosity. The viscosity is then determined by measuring the force to turn the spindle in the polymer solution at the shear rate. The viscosities measured at different polymer concentrations and temperatures in SW and TPW are summarized in Table 2, FIGS. 5-6.

The results show the significantly higher viscosity, e.g., about 6 to 18 times, of the TPW-based polymer solution compared to the SW-based polymer solution. This means that, with the TPW, a substantially lower amount of the polymer is required to achieve the same level of viscosity as a SW counterpart. For example, a polymer solution viscosity of about 20 cP can be achieved with the TPW using 0.025 wt. % polymer concentration at 25° C. when compared to 0.2 wt. % polymer concentration used in the SW. Similarly, at 75° C., the polymer consumption requirements were reduced from 0.2 wt. % to 0.025 wt. % to achieve a viscosity of about 13 cP by switching the water chemistry from SW to TPW. These results clearly demonstrate the benefits of TPW to significantly improve the economics of polymer flooding projects besides enabling produced water recycle/reuse and contributing to the environmental sustainability.

TABLE 2
Viscosity of SW- and TPW-based polymer solution

| | | |
|---|---|---|
| Polymer | Viscosity at | Viscosity at |
| concentration (wt. %) | 25° C. (mPa · s) | 75° C. (mPa · s) |

| | | | |
|---|---|---|---|
| 0.5 | (SW) | 140.4 | 90.2 |
| 0.2 | (SW) | 20.2 | 12.5 |
| 0.1 | (SW) | 8.5 | 4.02 |
| 0.05 | (SW) | 3.7 | 1.65 |
| 0.025 | (SW) | 2.05 | 0.93 |
| 0.5 | (TPW) | 928.2 | 875.2 |
| 0.2 | (TPW) | 214.8 | 180.3 |
| 0.1 | (TPW) | 80.2 | 72.2 |
| 0.05 | (TPW) | 33.4 | 21.5 |
| 0.025 | (TPW) | 19.97 | 13.3 |

### Implementations

An implementation described herein provides a method that includes: removing at least some portions of salts, H₂S and oil from a produced water to provide a treated produced water; dissolving a polymer in the treated produced water at a polymer concentration from 100 parts per million (ppm) to 1000 ppm to provide a polymer solution having a viscosity from 5 cP (mPa·s) to 100 cP (mPa·s) at a temperature from 20° C. to 22° C.; and injecting the polymer solution into a subterranean formation through a wellbore to recover hydrocarbons trapped in the subterranean formation.

In an aspect, combinable with any other aspect, a concentration of the salts in the produced water is from 50,000 ppm to 250,000 ppm, and a concentration of the salts in the treated produced water is less than 500 ppm.

In an aspect, combinable with any other aspect, a concentration of the salts in the produced water is from 20,000 ppm to 100,000 ppm, and a concentration of the salts in the treated produced water is less than 100 ppm.

In an aspect, combinable with any other aspect, removing of at least a portion of the salts from the produced water includes: heating the produced water to generate steam; and condensing the steam into a liquid.

In an aspect, combinable with any other aspect, a concentration of the H₂S in the produced water is from 100 ppm to 500 ppm, and a concentration of the H₂S in the treated produced water is less than 1 ppm.

In an aspect, combinable with any other aspect, a concentration of the H₂S in the produced water is from 50 ppm to 200 ppm, and a concentration of the H₂S in the treated produced water is less than 0.5 ppm.

In an aspect, combinable with any other aspect, removing of a portion of the H₂S from the produced water includes: flashing the produced water to form a gas including the H₂S; and capturing the H₂S in the gas using a gas scrubber.

In an aspect, combinable with any other aspect, a concentration of the oil in the produced water is from 50 ppm to 200 ppm, and a concentration of the oil in the treated produced water is less than 10 ppm.

In an aspect, combinable with any other aspect, a concentration of the oil in the produced water is from 20 ppm to 100 ppm, and a concentration of the oil in the treated produced water is less than 1 ppm.

In an aspect, combinable with any other aspect, the polymer includes a hydrolyzed polyacrylamide, a copolymer of acrylamide and acrylamide tertiary butyl sulfonate (ATBS), or a copolymer of acrylamide and acrylate.

In an aspect, combinable with any other aspect, the polymer solution has a viscosity from 5 cP (mPa·s) to 100 cP (mPa·s) at a temperature from 70° C. to 75° C.

In an aspect, combinable with any other aspect, the subterranean formation includes a carbonate reservoir or a sandstone reservoir.

In an implementation, a method includes: removing at least some portions of salts, H₂S and oil from a produced water to provide a treated produced water, the produced water including 50,000-250,000 parts per million (ppm) salts, 100-500 ppm hydrogen disulfide (H₂S), and 50-200 ppm oil to provide a treated produced water having a total salt content of less than 500 ppm, an H₂S content of less than 1 ppm, and an oil content of less than 10 ppm; dissolving a polymer in the treated produced water to form a polymer solution having a polymer concentration between 100 ppm and 1000 ppm, the polymer including a sulfonated polyacrylamide; and injecting the polymer solution into a subterranean carbonate formation through a wellbore to recover hydrocarbons trapped in the subterranean carbonate formation.

In an aspect, combinable with any other aspect, the polymer solution has a viscosity between 5 cP (mPa·s) to 100 cP (mPa·s) at a temperature from 20° C. to 22° C.

In an aspect, combinable with any other aspect the treated produced water has a total concentration of divalent cations of less than 2 ppm.

In an aspect, combinable with any other aspect, the produced water includes sulfates, chlorides, bicarbonates, sodium, potassium, calcium, and magnesium.

In an aspect, the treated produced water has a concentration for each of the sulfates, the potassium, the calcium, and the magnesium, of less than 2 ppm, and a concentration for each of the chlorides, the bicarbonates, the sodium of less than 50 ppm.

In an implementation, a method of oil production includes: drilling a wellbore into a subterranean carbonate formation including hydrocarbon; performing a primary production to recover the hydrocarbon through the wellbore from the subterranean carbonate formation; performing a secondary production to further recovering the hydrocarbon through the wellbore from the subterranean carbonate formation, the secondary production including injecting a fresh water into the subterranean carbonate formation through the wellbore, generating a produced water including salts, hydrogen disulfide (H₂S), and oil; pretreating the produced water to reduce an H₂S content, an oil content, and a total salt content in the produced water, thereby providing a treated produced water; preparing a polymer solution using the treated produced water, the polymer solution having a polymer concentration between 100 ppm and 1000 ppm; and performing an EOR, the EOR including injecting the polymer solution into the subterranean carbonate formation through the wellbore.

In an aspect, combinable with any other aspect the treated produced water has an H₂S content of less than 1 ppm, an oil content of less than 10 ppm, and a total salt content of less than 500 ppm.

In an aspect, combinable with any other aspect, the EOR further includes, after injecting the polymer solution into the wellbore, injecting a fluid to flush the injected polymer solution and the hydrocarbon out of the subterranean carbonate formation to a ground surface.

While this disclosure has been described with reference to illustrative implementations, this description is not intended to be construed in a limiting sense. Various modifications and combinations of the illustrative implementations, as well as other implementations, will be apparent to persons skilled in the art upon reference to the description. It is therefore intended that the appended claims encompass any such modifications or implementations.

What is claimed is:

1. A method, comprising:
removing at least some portions of salts, H₂S and oil from a produced water to provide a treated produced water;
dissolving a polymer in the treated produced water at a polymer concentration from 100 parts per million (ppm) to 1000 ppm to provide a polymer solution having a viscosity from 5 cP (mPa·s) to 100 cP (mPa·s) at a temperature from 20° C. to 22° C.; and
injecting the polymer solution into a subterranean formation through a wellbore to recover hydrocarbons trapped in the subterranean formation.

2. The method of claim 1, wherein a concentration of the salts in the produced water is from 50,000 ppm to 250,000 ppm, and wherein a concentration of the salts in the treated produced water is less than 500 ppm.

3. The method of claim 1, wherein a concentration of the salts in the produced water is from 20,000 ppm to 100,000 ppm, and wherein a concentration of the salts in the treated produced water is less than 100 ppm.

4. The method of claim 1, wherein removing of at least a portion of the salts from the produced water comprises:
heating the produced water to generate steam; and
condensing the steam into a liquid.

5. The method of claim 1, wherein a concentration of the H₂S in the produced water is from 100 ppm to 500 ppm, and wherein a concentration of the H₂S in the treated produced water is less than 1 ppm.

6. The method of claim 1, wherein a concentration of the H₂S in the produced water is from 50 ppm to 200 ppm, and wherein a concentration of the H₂S in the treated produced water is less than 0.5 ppm.

7. The method of claim 1, wherein removing of a portion of the H₂S from the produced water comprises:
flashing the produced water to form a gas comprising the H₂S; and
capturing the H₂S in the gas using a gas scrubber.

8. The method of claim 1, wherein a concentration of the oil in the produced water is from 50 ppm to 200 ppm, and wherein a concentration of the oil in the treated produced water is less than 10 ppm.

9. The method of claim 1, wherein a concentration of the oil in the produced water is from 20 ppm to 100 ppm, and wherein a concentration of the oil in the treated produced water is less than 1 ppm.

10. The method of claim 1, wherein the polymer comprises a hydrolyzed polyacrylamide, a copolymer of acrylamide and acrylamide tertiary butyl sulfonate (ATBS), or a copolymer of acrylamide and acrylate.

11. The method of claim 1, wherein the polymer solution has a viscosity from 5 cP (mPa·s) to 100 cP (mPa·s) at a temperature from 50° C. to 100° C.

12. The method of claim 1, wherein the subterranean formation comprises a carbonate reservoir or a sandstone reservoir.

13. A method, comprising:
removing at least some portions of salts, H₂S and oil from a produced water to provide a treated produced water, the produced water comprising 50,000-250,000 parts per million (ppm) salts, 100-500 ppm hydrogen disulfide (H₂S), and 50-200 ppm oil to provide a treated produced water having a total salt content of less than 500 ppm, an H₂S content of less than 1 ppm, and an oil content of less than 10 ppm;
dissolving a polymer in the treated produced water to form a polymer solution having a polymer concentration between 100 ppm and 1000 ppm, the polymer comprising a sulfonated polyacrylamide; and
injecting the polymer solution into a subterranean carbonate formation through a wellbore to recover hydrocarbons trapped in the subterranean carbonate formation.

14. The method of claim 13, wherein the polymer solution has a viscosity between 5 cP (mPa·s) to 100 cP (mPa·s) at a temperature from 20° C. to 22° C.

15. The method of claim 13, wherein the treated produced water has a total concentration of divalent cations of less than 2 ppm.

16. The method of claim 13, wherein the produced water comprises sulfates, chlorides, bicarbonates, sodium, potassium, calcium, and magnesium.

17. The method of claim 16, wherein the treated produced water has a concentration for each of the sulfates, the potassium, the calcium, and the magnesium, of less than 2 ppm, and a concentration for each of the chlorides, the bicarbonates, the sodium of less than 50 ppm.

18. A method of oil production, the method comprising:
drilling a wellbore into a subterranean carbonate formation comprising hydrocarbon;
performing a primary production to recover the hydrocarbon through the wellbore from the subterranean carbonate formation;
performing a secondary production to further recovering the hydrocarbon through the wellbore from the subterranean carbonate formation, the secondary production comprising injecting a fresh water into the subterranean carbonate formation through the wellbore, generating a produced water comprising salts, hydrogen disulfide (H₂S), and oil;
pretreating the produced water to reduce an H₂S content, an oil content, and a total salt content in the produced water, thereby providing a treated produced water;
preparing a polymer solution using the treated produced water, the polymer solution having a polymer concentration between 100 ppm and 1000 ppm; and
performing an enhanced oil recovery (EOR), the EOR comprising injecting the polymer solution into the subterranean carbonate formation through the wellbore.

19. The method of claim 18, wherein the treated produced water has an H₂S content of less than 1 ppm, an oil content of less than 10 ppm, and a total salt content of less than 500 ppm.

20. The method of claim 18, wherein the EOR further comprises, after injecting the polymer solution into the wellbore, injecting a fluid to flush the injected polymer solution and the hydrocarbon out of the subterranean carbonate formation to a ground surface.
